(19) United States
(12) Patent Application Publication
(10) Pub. No.: US 2021/0232581 A1
(43) Pub. Date: Jul. 29, 2021

(54) SYSTEMS AND METHODS FOR PROPAGATING TIMER MANAGEMENT AND EVENT TRIGGERING

(71) Applicant: COUPANG CORP., Seoul (KR)

(72) Inventors: Yao YUN, Shanghai (CN); Hou YU, Shanghai (CN)

(21) Appl. No.: 16/750,143

(22) Filed: Jan. 23, 2020

(51) Int. Cl. G06F 16/2458; G06Q 50/28; G06F 16/22; G06F 11/14; G06F 9/54

(52) U.S. Cl. CPC G06F 16/2477; G06Q 50/28; G06F 2201/84; G06F 11/1469; G06F 9/542; G06F 16/22

(57) ABSTRACT

A system for propagating timer management and event triggering includes one or more processors configured to receive, from a first system via a network, a request to instantiate a timer, the request comprising: an end time for the timer, and an event for triggering at the end time. The processors are further configured to save the received request to a data store comprising a plurality of requests, trigger the event upon reaching the end time for the timer associated with the request, and, responsive to triggering the event, send via a network, the event associated with the request.

### TECHNICAL FIELD

Embodiments of the present disclosure relate to systems and methods for propagating timer management and event triggering. More particularly, embodiments of the present disclosure relate to enabling users to order items online and deliver the items, by propagating timer management and event triggering for online orders.

### BACKGROUND

Users (e.g., online customers, online merchants, delivery personnel) often use online website portals or mobile applications to order items (e.g. order food, grocery). By way of example, users maintain profiles that includes user information (e.g. location information, menu, name) at the online websites. An online ordering process requires multiple stages of online order processing, from when an order is placed to when the order is delivered.

In a situation, where a user places an online order requesting food to be delivered, a first stage from multiple stages, would be for a merchant (e.g. a restaurant) to confirm the order or reject the order based on their availability to process the order. Sometimes, there is a significant time delay from when the order is placed to when the order is confirmed by the merchant, which would result in the online order to be kept pending during that time. Another stage would be sending a request to a delivery personnel to confirm or reject a pickup of order from the merchant based on their availability. Sometimes, there again may be a time delay from when a request is sent to the delivery personnel to the confirmation or rejection of the order by the delivery personnel, which would result in the online order to be delayed even further and thus resulting in significant delay for the user to receive the order. Similarly, through the various stages of processing of the online order there are various delays that result in inconvenience to the users and thus negatively impacting user experience.

Current solutions for managing online orders are generally ineffective in reducing and managing delays from the time an order is placed to the time the order is received by the user. In the current marketplace, processing of online orders is performed by various network devices across multiple networks, however there is no systematic method available that would reduce time delays between processing of orders across multiple network devices. Accordingly, current solutions for managing online order processing do not have the ability to consolidate, track, or analyze time delays and thus are ineffective, inflexible, and/or inefficient, resulting in reduced network processing efficiency. Moreover, there is a need for a system that monitors and reduces time delays incurred by merchants and delivery personnel as a result of onerous and manual nature of processing each request.

### SUMMARY

In accordance with embodiments of the present disclosure, there is provided a system for propagating timer management and event triggering, the system comprising: a memory storing instructions; and at least one processor configured to execute the instructions to: receive, from a first system via a network, a request to instantiate a timer, the request comprising: an end time for the timer, and an event for triggering at the end time; save the received request to a data store comprising a plurality of requests; trigger the event upon reaching the end time for the timer associated with the request; and responsive to triggering the event, sending, via a network, the event associated with the request.

In accordance with embodiments of the present disclosure, there is also provided a computer implemented method for receiving, from a first system via a network, a request to instantiate a timer, the request comprising: an end time for the timer, and an event for triggering at the end time; saving the received request to a data store comprising a plurality of requests; triggering the event upon reaching the end time for the timer associated with the request; and responsive to triggering the event, sending, via a network, the event associated with the request.

In accordance with embodiments of the present disclosure, there is provided a system for propagating timer management and event triggering, the system comprising: a memory storing instructions; and at least one processor configured to execute the instructions to: receiving, from a first system via a network, a request to instantiate a timer, the request comprising: an end time for the timer, and an event for triggering at the end time; saving the received request to a data store comprising a plurality of requests; triggering the event upon reaching the end time for the timer associated with the request; and responsive to triggering the event, sending, via a network, the event associated with the request.

### BRIEF DESCRIPTION OF DRAWINGS

The accompanying drawings, which are incorporated in and constitute a part of his specification, illustrate disclosed embodiments and, together with the description, serve to explain the disclosed embodiments. In the drawings:

FIG. 1 is a block diagram of an exemplary system, consistent with disclosed embodiments;

FIG. 2 is a block diagram of an exemplary server system, consistent with disclosed embodiments;

FIG. 3 is a block diagram of an exemplary user device, consistent with disclosed embodiments;

FIG. 4 contains a detailed flowchart of an exemplary process of propagating timer management and event triggering, consistent with disclosed embodiments; and

FIG. 5 contains a flow diagram illustrating an exemplary process of FIG. 4, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

While the following description is directed to propagating timer management and event triggering, those embodiments are made by example only. It should be appreciated that the present disclosure is not limited to the specific disclosed embodiments and details. It is further understood that one possessing ordinary skill in the art, in light of known systems and methods, would appreciate the use of the embodiments of the present disclosure for their intended purposes and benefits in any number of alternative embodiments, depending on specific design and other needs.

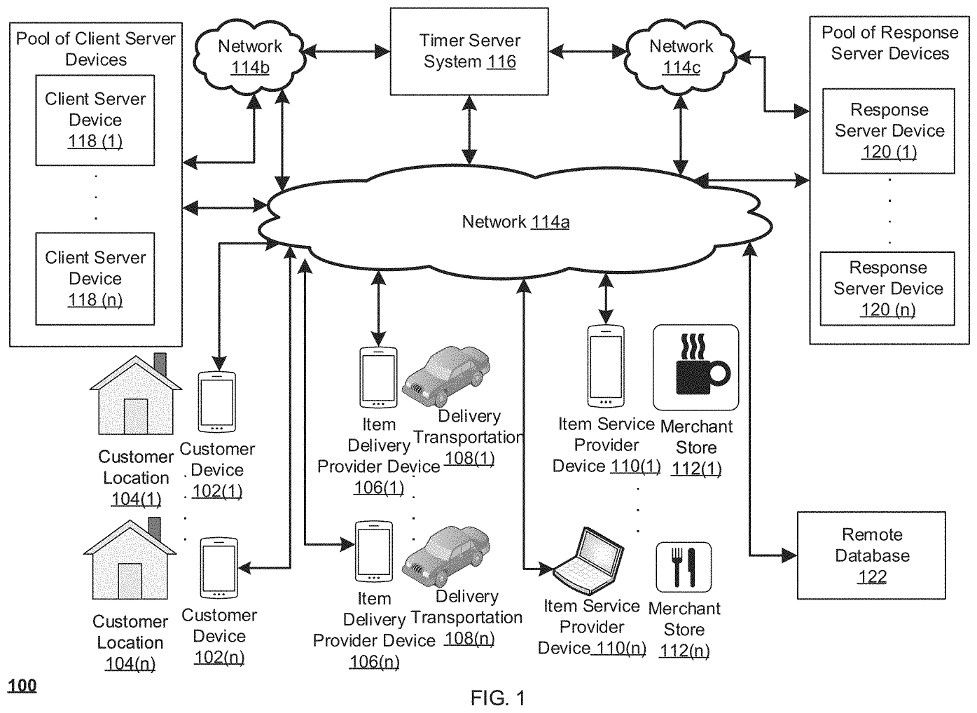

FIG. 1 is a block diagram of an exemplary system 100, for performing one or more operations consistent with disclosed embodiments. In some embodiments, system 100 includes one or more customer devices 102(1), . . . 102(n) located at corresponding customer location 104(1), . . . 104(n) respectively, one or more item delivery provider devices 106(1), . . . 106(n) located in corresponding delivery transportation 108(1), . . . 108(n) respectively, one or more item service provider devices 110(1), . . . 110(n) located at corresponding merchant stores 112(1), . . . 112(n), client server device 118(1), . . . client server device 118(n) form a pool of client server devices and response server device 120(1), . . . response server device 120(n), form a pool of response server devices. Further, system 100 includes a timer server system 116, a remote database 122 and network 114a, network 114b, and network 114c. The system 100 may also include a plurality of timer server systems 116 (not shown in drawings) and a plurality of remote databases 122 (not shown in drawings) communicating with each other directly and further communicating with customer devices 102(1)-102(n), item delivery provider devices 106(1)-106(n), item service provider devices 110(1)-110(n) via the network 114a. Pool of client server devices 118(1)-118(n) communicate with timer server system 116 via network 114b. Pool of response server devices 120(1)-120(n) communicate with timer server system 116 via network 114c. In another example, the pool of client server devices 118(1)-118(n) and pool of response server devices 120(1)-120(n) communicate over the network 114a, network 114b and network 114c with the timer server system 116, customer devices 102(1)-102(n), item delivery provider devices 106(1)-106(n) and item service provider devices 110(1)-110(n) and remote database 122.

The components and arrangement of the components included in system 100 may vary. Thus, system 100 may include other components that perform or assist in the performance of one or more operations consistent with the disclosed embodiments.

As more fully described below, customer devices 102(1)-102(n), item delivery provider devices 106(1)-106(n), item service provider devices 110(1)-110(n), timer server system 116, pool of client server devices 118(1)-118(n), pool of response server devices 120(1)-120(n), and remote database 122 may include one or more computing devices (e.g., computer(s), server(s), etc.), memory storing data and/or software instructions (e.g., database(s), memory devices, etc.), and other known computing components. In some embodiments, the one or more computing devices may be configured to execute software instructions stored in the memory to perform one or more operations consistent with the disclosed embodiments. Aspects of customer device(s) 102(1)-102(n), item delivery provider device(s) 106(1)-106(n), item service provider devices 110(1)-110(n), Timer server system 116, pool of client server devices 118(1)-118(n), pool of response server devices 120(1)-120(n), and remote database 122 may be configured to communicate with one or more other components of system 100 via network 114a, network 114b and network 114c, for example. In certain aspects, customers associated with the customer location 104(1)-104(n) are respectively associated with and operate customer devices 102(1)-102(n), drivers associated with the delivery transportation 108(1)-108(n) are respectively associated with and operate item delivery provider devices 106(1)-106(n), merchants associated with the merchant stores 112(1)-112(n) are respectively associated with and operate item service provider devices 110(1)-110(n), to interact with one or more components of system 100 by sending and receiving communications, initiating operations, and/or providing input for one or more operations consistent with the disclosed embodiments.

Timer server system 116 may be associated with an online ordering entity that receives, processes, manages, or otherwise offers ordering services for items. For example, the items that may be ordered via the online ordering entity may include, food, grocery, furniture, books, computers, and/or clothes, although any other type of items may also be ordered. For example, the timer server system 116 receives order requests from customers using customer devices 102(1)-102(n) and transmits the request to item service provider devices 110(1)-110(n) associated with merchant stores 112(1)-112(n) that would provide the ordered item. Timer server system 116 receives an order confirmation from item service provider devices 110(1)-110(n). Upon receiving the order confirmation from the item service provider devices 110(1)-110(n), timer server system 116 transmits a request to item delivery provider devices 106(1)-106(n), to collect the order from the merchant stores 112(1)-112(n) and deliver the order to customer residence 104(1)-104(n). Item delivery provider devices 106(1)-106(n) accepts the requests and collects the requested item and delivers it to the customer residence 104(1)-104(n).

Remote database 122 of system 100 may be communicatively coupled to timer server system 116 directly or via network 114a, network 114b and/or network 114c. Further, the remote database 122 of system 100 may be communicatively coupled to customer devices 102(1)-102(n), item delivery provider devices 106(1)-106(n) and item service provider devices 110(1)-110(n) via the communication network 114a. Remote database 122 may include one or more memory devices that store information and are accessed and/or managed by one or more components of system 100. By way of example, remote database 122 may include Oracle™ databases, Sybase™ databases, or other relational databases or nonrelational databases, such as Hadoop sequence files, HBase, or Cassandra. Remote database 122 may include computing components (e.g., database management system, database server, etc.) configured to receive and process requests for data stored in memory devices of remote database 122 and to provide data from remote database 122.

Remote database 122 is configured to store, among another things, merchant profile information for merchants associated with the item service provider devices 110(1)-110(n) located at the merchant stores 112(1)-112(n), customer profile information for customers associated with the customer devices 102(1)-102(n) located at the customer residences 104(1)-104(n) and driver profile information for the drivers associated with the item delivery provider devices 106(1)-106(n). Merchant profile information, customer profile information and driver profile information are stored as data entries in remote database 122.

The merchant stores 112(1)-112(n) may include a restaurant, coffee shop, bookstore, clothing stores, although any other type of stores can also be included. Further, merchant profile information includes service level agreements associated with the merchant, although any other type of information associated with the merchant can also be included. The service level agreement may include a time period within which the merchant stores 112(1)-112(n) would confirm an order in response to a request from a customer, although any other type of information associated with service level agreements can also be included. The customer location 104(1)-104(n) may include a residential location, an office building, an apartment, although any other type of residence can also be included. Further, customer profile information includes a time period within which an order placed by a customer by utilizing customer devices 102(1)-102(n) is to be confirmed by merchant stores 112(1)-112(n), although any other type of information associated with service level agreements can also be included. The delivery transportation 108(1)-108(n) may include a car, bike, truck, or bus, although any other type of transportation may also be included. Further, driver profile information includes a time period within which delivery personnel much confirm a pickup request received from the merchant stores 112(1)-112(n), although any other type of information associated with the service level agreements can also be included.

Remote database 122, in some embodiments, stores key-value data structures. Key-value data structure stores data as records that have different fields within them. These records are stored and retrieved using a key that uniquely identifies the record and is further used to quickly find the data within the database. By way of example, end time for a request may be stored as a key and a corresponding event associated with the end time may be stored as a value. End time for a request is a time period after which a timer is triggered to perform an event. In this example, an end time may be 20 minutes and corresponding event may be upon completion of 20 minutes, if it is determined that a confirmation response has not been received, then transmit a cancel order request to response server devices 120(1)-120(n) associated with the request.

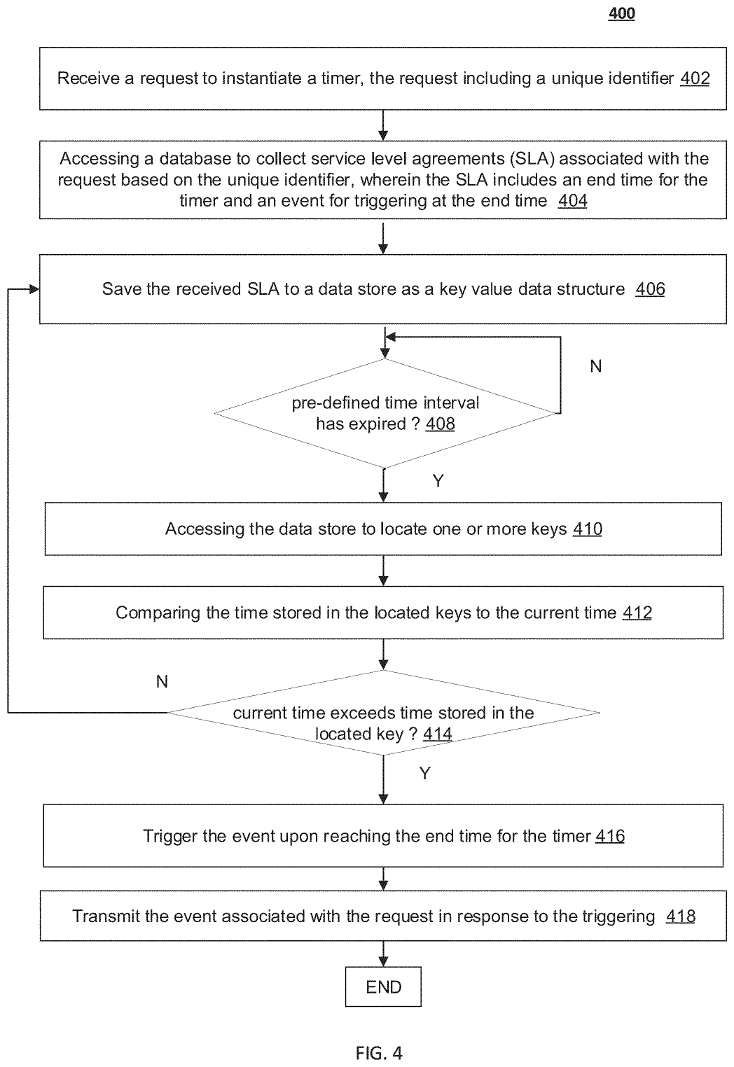

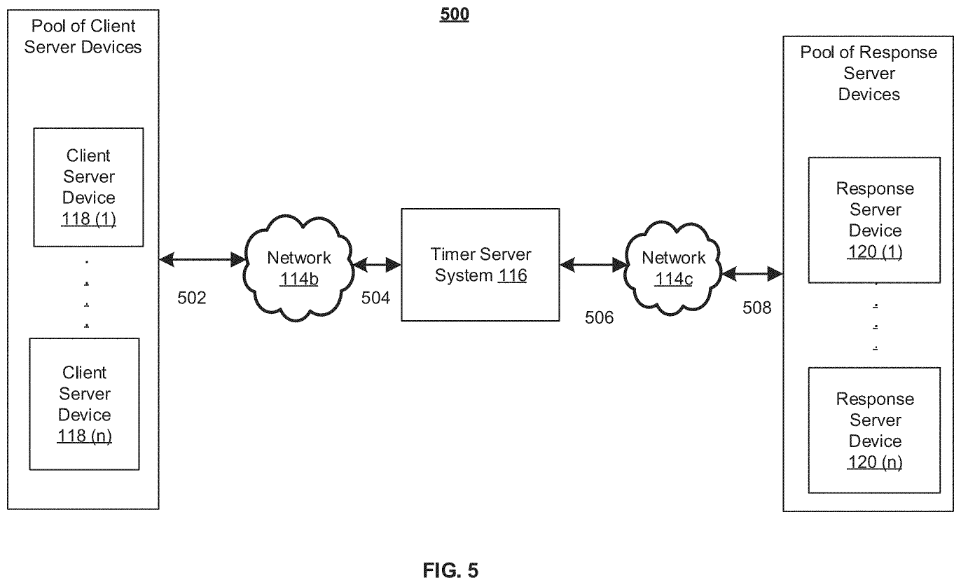

In one aspect, timer server system 116 may include one or more computing devices, configured to perform one or more operations consistent with disclosed embodiments as described more fully below in relation to FIG. 4 and FIG. 5. In one aspect, Timer server system 116 may include one or more servers or server systems. Timer server system 116 may include one or more processors configured to execute software instructions stored in a memory or other storage device. The one or more processors may be configured to execute the stored software instructions to perform internet-related communication, online order-based processes, and propagating timer management and event triggering. The one or more computing devices of timer server system 116 may be configured to track and store time delays between transmission of a request and receiving a confirmation of the request, and trigger an event associated with the request based on tracking of time delays. The one or more computing devices of timer server system 116 may also be configured to communicate with other components of system 100 to propagate a timer management and event triggering. In some embodiments, timer server system 116 may provide one or more mobile applications, web-sites or online portals that are accessible by customer devices 102(1)-102(n), item delivery provider devices 106(1)-106(n), item service provider device 110(1)-110(n), pool of client server devices 118(1)-118(n), and response server devices 120(1)-120(n) over network 114a, network 114b and network 114c. The disclosed embodiments are not limited to any particular configuration of timer server system 116.

In one aspect, pool of client server devices 118(1)-118(n) may include one or more computing devices, configured to perform one or more operations consistent with disclosed embodiments as described more fully below in relation to FIG. 4 and FIG. 5. In one aspect, each of the client server devices 118(1)-118(n) may include one or more servers or server systems. Client server devices 118(1)-118(n) may include one or more processors configured to execute software instructions stored in a memory or other storage device. The one or more processors may be configured to execute the stored software instructions to perform internet-related communication, online order-based processes, and propagating timer management and event triggering. The one or more computing devices of client server devices 118(1)-118(n) may be communicate with timer server system 116 over network 114b. The one or more computing devices of client server devices 118(1)-118(n) may also be configured to communicate with other components of system 100 to propagate a timer management and event triggering. In some embodiments, client server devices 118(1)-118(n) may provide one or more mobile applications, web-sites or online portals that are accessible by customer devices 102(1)-102(n), item delivery provider devices 106(1)-106(n), item service provider device 110(1)-110(n), and response server devices 120(1)-120(n) over network 114a, network 114b and network 114c. The disclosed embodiments are not limited to any particular configuration of client server devices 118(1)-118(n).

In one aspect, pool of response server devices 120(1)-120(n) may include one or more computing devices, configured to perform one or more operations consistent with disclosed embodiments as described more fully below in relation to FIG. 4 and FIG. 5. In one aspect, each of the response server devices 120(1)-120(n) may include one or more servers or server systems. Response server devices 120(1)-120(n) may include one or more processors configured to execute software instructions stored in a memory or other storage device. The one or more processors may be configured to execute the stored software instructions to perform internet-related communication, online order-based processes, and propagating timer management and event triggering. The one or more computing devices of response server devices 120(1)-120(n) may be communicate with timer server system 116 over network 114c. The one or more computing devices of response server devices 120(1)-120(n) may also be configured to communicate with other components of system 100 to propagate a timer management and event triggering. In some embodiments, response server devices 120(1)-120(n) may provide one or more mobile applications, web-sites or online portals that are accessible by customer devices 102(1)-102(n), item delivery provider devices 106(1)-106(n), item service provider device 110(1)-110(n), and client server devices 118(1)-118(n) over network 114a, network 114b and network 114c. The disclosed embodiments are not limited to any particular configuration of response server devices 120(1)-120(n).

Network 114a, network 114b and network 114c may comprise any type of computer networking arrangement configured to provide communications or exchange data, or both, between components of system 100. For example, network 114a, network 114b and network 114c may include any type of network (including infrastructure) that provides communications, exchanges information, and/or facilitates the exchange of information, such as the Internet, a private data network, a virtual private network using a public network, a LAN or WAN network, a Wi-Fi™ network, and/or other suitable connections that may enable information exchange among various components of system 100. Network 114a, network 114b and network 114c may also include a public switched telephone network (“PSTN”) and/or a wireless cellular network. Network 114a, network 114b and network 114c may be a secured network or unsecured network. In some embodiments, one or more components of system 100 may communicate directly through a dedicated communication link(s).

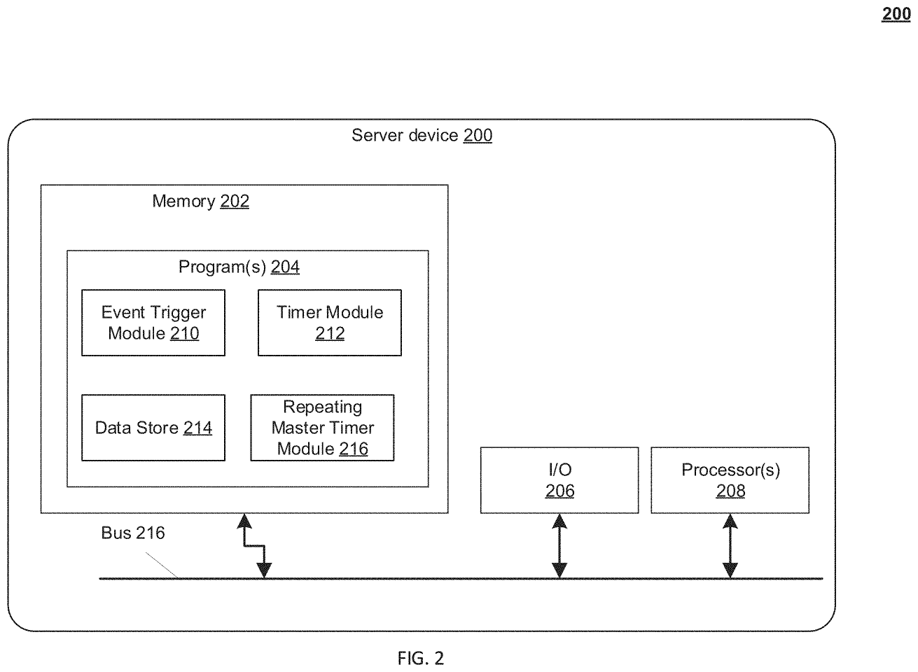

Customer devices 102(1)-102(n), item delivery provider devices 106(1)-106(n), item service provider devices 110(1)-110(n) may be one or more computing devices configured to perform one or more operations consistent with the disclosed embodiments, as described more fully below in relation to FIG. 2. Customer devices 102(1)-102(n), item delivery provider devices 106(1)-106(n), item service provider devices 110(1)-110(n) may execute browser or related mobile display software that displays an online portal for placing online orders for delivery of items, receiving orders and delivering items that are ordered, on a display included in, or connected to, customer devices 102(1)-102(n). Customer devices 102(1)-102(n) may also store and execute other mobile applications that allow customers, merchants, and/or drivers to interact with an online portal provided by the Timer server system 116.

It is to be understood that the configuration of the functional blocks of system 100 has been defined herein for convenience of description. The components and arrangement of the components included in system 100 may vary. For example, in some embodiments, system 100 may include other components that perform or assist in the performance of one or more processes consistent with disclosed methods. System 100 includes a number of components generally described as computing devices. Each of the computing devices may include any number of computing components particularly configured as a special purpose computing device to perform the functionality disclosed herein. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

FIG. 2 shows an exemplary server device 200 consistent with the disclosed embodiments. Variations of exemplary server device 200 may constitute one or more components of timer server system 116. In one embodiment, server device 200 includes one or more memories 202, one or more I/O devices 206, and one or more processors 208. In some embodiments, server device 200 may be a part of timer server system 116. In some embodiments, server device 200 may take the form of a specially programmed server or computing system used by timer server system 116 to perform complete functions of timer server system 116. In some embodiments, server device 200 may be configured as an apparatus, embedded system, dedicated circuit, or the like based on the storage, execution, and/or implementation of software instructions that perform one or more operations consistent with the disclosed embodiments.

Memory 202 may include one or more storage devices configured to store instructions used by processor 208 to perform functions related to disclosed embodiments. For example, memory 202 may be configured with one or more software instructions, such as program(s) 204 that may perform one or more operations when executed by processor 208. The disclosed embodiments are not limited to separate programs or computers configured to perform dedicated tasks. For example, memory 202 may include a single program 204 that performs the functions of server device 200, or program 204 may comprise multiple programs. In certain embodiments, memory 202 may store sets of instructions or programs 204 for performing functions of timer server system 116. These sets of instructions may be executed by processor 208 to perform communication and/or processes consistent with disclosed embodiments.

In certain embodiments, when server device 200 constitutes one or more of the components of timer server system 116, memory 202 includes an event trigger module 210, timer module 212, data store 214, and repeating master timer module 216, as described in detail below.

In another example, each of the event trigger module 210, timer module 212, data store 214, and repeating master timer module 216, may be implemented as separate and individual servers communicating with each other, client server devices 118(1)-118(n), response server devices 120(1)-120(n), and remote database 122 over network 114a, network 114b and network 114c. In another example, data store 214 may be hosted at remote database 122.

Input/output (I/O) 206 may include various input/output devices, such as a keyboard, a mouse-type device, a gesture sensor, an action sensor, a physical button, switch, microphone, touchscreen panel, stylus, etc., that may be manipulated by customer devices 102(1)-102(n), item delivery provider device 106(1) and/or item service provider device 110(1)-110(n). I/O devices 206 may also include an audio output device. Exemplary communication modules of I/O devices 206 may include, for example, a short-range or near field wireless communication modem, a Wi-Fi™ communication modem, or a cellular communication modem. I/O devices 206 may include a transceiver or transmitter configured to communicate using one or more wireless technologies/protocols that may include, without limitation, cellular (e.g., 3G, 4G, etc.) technology, Wi-Fi™ hotspot technology, RFID, near-field communication (NFC) or BLUETOOTH® technologies, etc. More generally, any uni- or bi-directional communication technology known to one of ordinary skill in the art may be implemented in server device 200 to exchange information with timer server system 116, customer devices 102(1)-102(n) item delivery provider device 106(1), item service provider device 110(1)-110(n), client server devices 118(1)-118(n), response server devices 120(1)-120(n), or remote database 122 via network 114a, network 114b and/or network 114c.

Processor 208 may include one or more known processing devices, such as a microprocessor from the Pentium™ or Xeon™ family manufactured by Intel™, or the Turion™ family manufactured by AMD™, for example. The disclosed embodiments are not limited to any type of processor(s) otherwise configured to meet the computing demands required of different components of system 100.

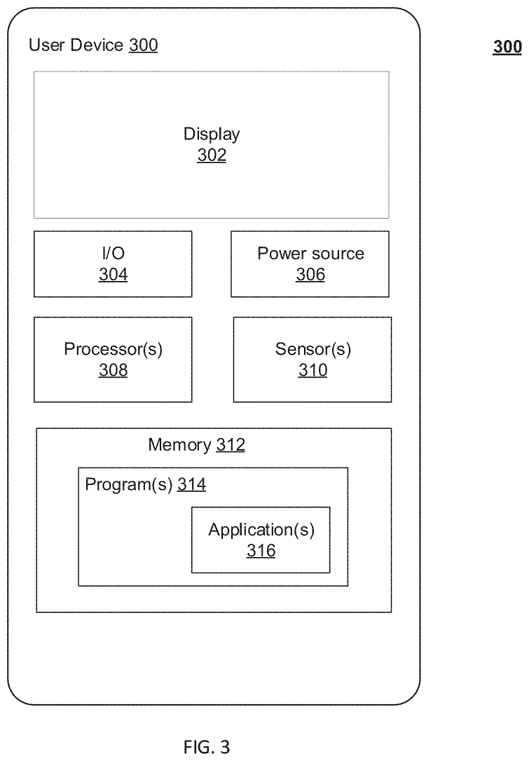

FIG. 3 shows an exemplary configuration of user device 300, consistent with disclosed embodiments. User device 300 of FIG. 3 represents an exemplary configuration of each of the customer devices 102(1)-102(n), the item delivery provider devices 106(1)-106(n) and item service provider devices 110(1)-110(n).

User device 300 may enable associated customers, drivers and merchants associated with customer devices 102(1)-102(n), the item delivery provider devices 106(1)-106(n) and item service provider devices 110(1)-110(n) respectively to perform remote interactions or mobile transactions with timer server system 116, for example, or receive information from timer server system 116. In some embodiments, user device 300 may be a personal computing device. For example, user device 300 may be a smartphone, a laptop or notebook computer, a tablet, a multifunctional watch, a pair of multifunctional glasses, or any mobile or wearable device with computing ability, or any combination of these computers and/or affiliated components.

User device 300 includes one or more processors 308 configured to execute software instructions stored in memory, such as a memory 312. Memory 312 may store one or more software programs 314 that when executed by processor 308 perform known Internet-related communication, content display processes, and other interactive processes for customers, drivers and/or merchants. For instance, user device 300 may execute a browser or related mobile display software that generates and displays interfaces including content on a display device 302 included in, or in communication with, user device 300. User device 300 may be a mobile device that executes mobile device applications and/or mobile device communication software, included in programs 314, that allows user device 300 to communicate with timer server system 116 and other components via network 114a, network 114b and/or network 114c, to generate and display content in interfaces via display device 302. The disclosed embodiments are not limited to any particular configuration of user device 300. User device 300 may include any arrangement of one or more computing devices configured to perform one or more operations consistent with disclosed embodiments.

User device 300 may be configured to store, in memory 312, one or more operating systems that perform known operating system functions when executed by processor 308. By way of example, the operating systems may include Microsoft Windows™, Unix™, Linux™, Android™, Apple™ Mac OS operating systems, iOS, Chrome OS, or other types of operating systems. Accordingly, disclosed embodiments may operate and function with computer systems running any type of operating system. User device 300 may also include communication software stored in memory 312 that, when executed by processor 308, provides communications with network 114a, network 114b and/or network 114c, such as Web browser software, tablet or smart handheld device networking software, etc.

Display device 302 may include, for example, a liquid crystal displays (LCD), a light emitting diode screens (LED), an organic light emitting diode screen (OLED), a touch screen, and other known display devices. Display device 302 may display various information to customers, drivers and merchants. For example, display device 302 may display an interactive interface enabling customers, drivers and merchants to operate user device 300 to perform certain aspects of the disclosed methods. Display device 302 may display touchable or selectable options for customers, drivers and merchants to select and may receive customer selection of options through a touch screen.

User device 300 includes I/O devices 304 that allows to send and receive information or interact with customers, drivers and merchants or another device. For example, I/O devices 304 may include various input/output devices, such as a keyboard, a mouse-type device, a gesture sensor, an action sensor, a physical button, switch, microphone, touchscreen panel, stylus, etc., that may be manipulated by customers, drivers and merchants to input information using user device 300. I/O devices 304 may also include an audio output device, such as a speaker configured to provide sound and audio feedback to customers, drivers and merchants operating user device 300. In some embodiments, I/O devices 304 may include a light emitting component, such as a LED or other component capable of providing a visible signal to customers, drivers and merchants. I/O devices 304 may also include haptic output devices, to provide haptic feedback to customers, drivers and merchants. I/O devices 304 may also include one or more communication modules (not shown) for sending and receiving information from other components in system 100 by, for example, establishing wired or wireless connectivity between user device 300 network 114a, network 114b and/or network 114c. I/O devices 304 may include radio frequency, infrared, or other near-field communication interfaces, for communicating with other devices associated with network 114a, network 114b and/or network 114c. Exemplary communication modules of I/O devices 304 may include, for example, a short-range or near field wireless communication modem, a Wi-Fi™ communication modem, or a cellular communication modem. I/O devices 304 may include a transceiver or transmitter configured to communicate using one or more wireless technologies/protocols that may include, without limitation, cellular (e.g., 3G, 4G, etc.) technology, Wi-Fi™ hotspot technology, RFID, near-field communication (NFC) or BLUETOOTH® technologies, etc. More generally, any uni- or bi-directional communication technology known to one of ordinary skill in the art may be implemented in user device 300 to exchange information with timer server system 116 or remote database 122 via network 114a, network 114b and/or network 114c.

As described above, user device 300 may be a device that executes mobile applications for performing operations consistent with disclosed embodiments. Thus, in some embodiments, programs 314 stored on user device 300 may include one or more software applications 316 installed thereon, that enable user device 300 to communicate with timer server system 116 via network 114a, network 114b and/or network 114c and perform aspects of the disclosed methods. For example, user device 300 may connect to timer server system 116 by using browser software to access and receive information or perform other operations associated with an internet service provider.

According to an exemplary embodiment, software applications 316 associated with timer server system 116 may be installed on user device 300, as shown in FIG. 3. For example, timer server system 116 may receive a request from customer device 102(1) to download one or more software applications 316 to user customer device 102(1). In one embodiment, timer server system 116 may receive the request from a customer associated with customer device 102(1), using a web browser application installed on customer device 102(1) respectively. In another embodiment, timer server system 116 may receive the request to download one or more software applications 316 associated with timer server system 116 onto customer device 102(1) from a webpage or another portal associated with timer server system 116 accessed via, e.g., customer device 102(1). In this embodiment, timer server system 116 may store software instructions corresponding to one or more software applications 316 in remote database 122. For responding to the download request, timer server system 116 may receive additional information from customer device 102(1) regarding the particular device specifications of customer device 102(1) to enable customer device 102(1) to download software instructions corresponding to the particular specifications. Alternatively, timer server system 116 may push a download request link to customer device 102(1) or transmit software code corresponding to one or more software applications 316 directly to customer device 102(1) in, for example, an e-mail, a text or short message service (SMS) message, a prompt through an app, or other suitable method. Customer device 102(1) may receive the software code related to one or more software applications 316, such as via network 114a, network 114b and/or network 114c, to download and install the software code. Similarly, in another example, timer server system 116 may receive a request from a driver associated with item delivery provider device 106(1) to download one or more software applications 316 onto the item delivery provider device 106(1). Further, similarly, in another example, timer server system 116 may receive a request from a merchant associated with item service provider device 110(1) to download one or more software applications 316 onto the item service provider device 110(1).

FIG. 4 contains a flowchart of an exemplary process 400 implemented by timer server system 116 for propagating timer management and event triggering, consistent with the disclosed embodiments. Timer server system 116 is implemented as a server device 200 of FIG. 2 to execute software instructions that perform one or more of the operations of process 400. Operations of process 400 are explained in association with FIG. 5, while FIG. 5 contains a flow diagram illustrating an exemplary process of FIG. 4,

FIG. 5 illustrates pool of client server devices 118(1)-118(n) in communication with network 114b over 502, network 114b communicating with timer server system 116 over 504, timer server system 116 communicating with network 114c over 506, and network 114c in communication with response server devices 120(1)-120(n) over 508.

In accordance with process 400, in step 402, server device 200 of timer server system 116 receives a client request to instantiate a timer module 212 from one of a client server devices 118(1)-118(n). By way of example, a customer associated with customer device 102(1) may place an online order to request food from a merchant store 112(1). The online order is a client request generated by customer device 102(1) and the client request may include order information. Order information may include a customer identifier, a merchant store identifier where the customer is requesting food from, a dish name the customer is requesting, time of order, time when the customer wants the food delivered, location where the customer wants the food delivered, name of the customer, customer payment information, although any other online order information may be also included. Further, customer payment information includes credit card number, debit card number, online bank account number, although any other customer payment information may be included. Customer device 102(1) transmits the generated client request via network 114a to one of a client server device 118(1)-118(n) based on network load and availability, in this example, the customer device 102(1) transmits the client request to client server device 118(1). Client server device 118(1) upon receiving the client request transmits the client request via network 114b (as shown in flow 502 of FIG. 5), and from network 114b to server device 200 of timer server system 116 (as shown in flow 504 of FIG. 5). Server device 200 receives the client request from client server device 118(1).

In another example, customer device 102(n) may generate a client request and transmit it to one of the client server devices 118(1)-118(n). In this example customer device 102(n) transmits the client request to client server device 118(n). In another example, customer device 102(n) transmits the client request to client server device 118(1).

In step 404, server device 200 of timer server system 116 determines the received client request to include a merchant store identifier where the customer is requesting food from merchant stores 112(1)-112(n). Merchant store identifier is a unique identifier identifying the merchant store associated with the order. By way of example, merchant identifier may be a name or an email address associated with the merchant included in the client request. Based on the unique identifier, server device 200 accesses remote database 122 to identify merchant profile information corresponding to the determined unique identifier. In some embodiments, server device 200 accesses a lookup table at remote database 122 to identify merchant profile information corresponding to the determined unique identifier. Server device 200 collects merchant profile information from remote database 122. Further, merchant profile information may include service level agreements (SLA) associated with merchants corresponding to the unique identifier. Service level agreements may include an end time and an event triggering at the end time. End time is a time period by which merchant stores 112(1)-112(n) would confirm an order in response to the client request, although any other type of information associated with service level agreements can also be included. End time for a request, is a time period after which a timer is triggered to perform an event. In this example, an end time may be 20 minutes and corresponding event may be upon completion of 20 minutes. In this example, if server device 200 determines that a confirmation response has not been received, then server device 200 transmits a cancel order request to response server devices 120(1)-120(n) associated with the request.

In another example, based on the unique identifier, server device 200 of timer server system 116, accesses data store 214 to identify merchant profile information stored in the data store 214 corresponding to the determined unique identifier.

In step 406, server device 200 of timer server system 116 saves the SLA to a data store as a key value data structure. Server device 200 stores the end time as a key structure in the data store 214 and further stores the event triggering at the end time as an associated value of the key. Further, server device 200 of timer server system 116, periodically stores snapshots of the key-value data store on data store 214. Further, when server device 200 determines that data loss has occurred in the key-value data store due to power outage, program error, or other incident, then server device 200 reads the stored snapshots and restores data to the key-value data store using the stored snapshots.

In step 408, server device 200 of timer server system 116 determines if a pre-defined time interval has expired. Repeating master timer module 216 determines if a pre-defined time interval has expired. By way of example, the pre-defined time interval is 5 seconds, although any other time period may also be included. When repeating master timer module 216 determines that the pre-defined time interval has not expired, then the method loops back to step 408 to repeat the process of identifying if a pre-defined time interval has expired. When rep master timer module 216 determines that the pre-defined time interval has expired, then the method proceeds to step 410.

In step 410, server device 200 of timer server system 116 accesses data store 214 to locate one or more keys stored in step 406. By way of example, server device 200 identifies the end time as a key structure stored in data store 214. In this example, the end time is 15 minutes.

In step 412, server device 200 of timer server system 116 includes an event trigger module 210 that compares the time stored of the key located in step 410 with the current time. Timer module 212 determines a current time. Current time is the time elapsed since the time server system 116 receives the client request.

In step 414, server device 200 of timer server system 116 determines if the current time exceeds the time stored in the located key. By way of example, when event trigger module 210 compares the time stored in the key (in this example, the time stored in the key is 20 minutes), and the current time (in this example, the current time is determined by the timer module 212 to be 19 minutes). Based on the comparison, it is determined that the current time is less than the time stored in the located key i.e. the current time does not exceed the time stored in the located key, as a result the method loops back to step 408.

However, by way of another example, when event trigger module 210 compares the time stored in the key, in this example, the time stored in the key is 20 minutes, and the current time, in this example, is determined by the time module to be 20 minutes and 30 seconds. Based on the comparison, it is determined that the current time is more than the time stored in the located key i.e. the current time exceeds the time stored in the located key, as a result the method moves to step 416.

In step 416, server device 200 of timer server system 116, triggers the event corresponding to the end time key, as it is determined in step 414 that the end time has been reached. As the event trigger module 210 of the server device 200 determines that an end time has been reached and a confirmation response has not been received by the end time, then server device 200 triggers an event associated with the key. In this example, the event to be triggered is to transmits a cancel order request to response server devices 120(1)-120(n) associated with the client request.

In step 418, server device 200 of timer server system 116, transmits a cancel order request as a notification to response server device 120(1)-120(n) associated with the client request.

As another example, back in step 402, item service provider devices 110(1)-110(n) may generate a merchant request and transmit it to timer server system 116. Merchant request may be a request for the merchant requesting a delivery personnel associated with item delivery provider devices 106(1)-106(n) to accept order pickup from merchant stores 112(1)-112(n).

As another example, back in step 402, item delivery provider devices 106(1)-106(n) may generate a delivery request and transmit it to timer server system 116. Delivery request may be a request from item delivery provider devices 106(1)-106(n) associated with delivery personnel for delivering of the order at customer location 104(1)-104(n).

The disclosed embodiments provide an improved method of propagating timer management and event triggering. By providing technical advantages of an optimized process of reducing time delays and providing a real time process of identifying inefficiencies between ordering stages. As this technology provides triggering of events associated with time period expiration of a request by a timer, this technology provides a fast and reliable process of reducing time delays, which results in faster processing of orders. Thus, this technology reduces delays caused during online order processing by identifying specific locations where a delay occurs, and thus triggers an event directed to that network component associated with the delay. Thus, this technology reduces data overhead and data resources, required for processing online orders that are being pending for longer time periods.

In contrast, in the prior art, other strategies that have been implemented are inefficient as they require extra data overhead and resources, which may not be beneficial to efficiently utilize network resources and thus increase network load. Further the prior art does causes significant delays during online ordering process, instead this technology provides a real time online ordering system, that reduces delays improves network efficiency.

While illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments.

The elements in the claims are to be interpreted broadly based on the language employed in the claims and not limited to examples described in the present specification or during the prosecution of the application, which examples are to be construed as non-exclusive. It is intended, therefore, that the specification and examples be considered as exemplary only, with a true scope and spirit being indicated by the following claims and their full scope of equivalents.

1. A computer-implemented system for propagating timer management and event triggering, the system comprising:
a memory storing instructions; and
at least one processor configured to execute the instructions to:
receive, from a first system via a network, a request to instantiate a timer, the request comprising at least one unique identifier;
accessing a service level agreement in at least one database based on the at least one unique identifier;
determining, based on the service level agreement:
an end time for the timer, and
an event for triggering at the end time;
save the received request to a data store comprising a plurality of requests;
upon reaching the end time for the timer associated with the request, trigger the event by sending instructions to perform cancellation of an online order associated with the request; and
responsive to triggering the event, sending, via a network, the event associated with the request.

2. The system of claim 1, wherein the data store comprising the plurality of requests comprises a key-value data structure.

3. The system of claim 2, wherein the received request is stored in the data store by storing the end time for the respective timer as a key and the event as an associated value.

4. The system of claim 3, wherein the instructions further cause the processor to:
maintain a repeating master timer with a pre-defined interval;
determining that the repeating master timer interval has expired; and
based on determining that the repeating master time interval has expired:
locating one or more keys in the data store;
comparing the time stored in the located keys to the current time;
triggering the associated event for at least one located key with an associated time in the past.

5. The system of claim 2, wherein the instructions further cause the processor to:
periodically store snapshots of the key-value data store on a computer-readable medium;
determine that data loss has occurred in the key-value data store due to power outage, program error, or other incident;
reading the stored snapshots; and
restoring data to the key-value data store using the stored snapshots.

6. The system of claim 1, wherein the instructions further cause the processor to:
maintain a repeating master timer with a pre-defined interval;
determining that the repeating master timer interval has expired; and
based on determining that the repeating master time interval has expired:
consulting the data store to determine one or more requests whose respective end times have been reached;
triggering the associated event for the one or more determined requests.

7. The system of claim 1, wherein the event for triggering at the end time comprises
sending a notification to a destination system indicating that the timer has elapsed.

8. The system of claim 1, wherein the instructions further cause the processor to:
receive, from the first system, a request to cancel the timer; and
clear the received request from the data store.

9. The system of claim 1, wherein sending the event comprises sending the event to the first system.

10. A computer implemented method for propagating timer management and event triggering, the method comprising:
receiving, from a first system via a network, a request to instantiate a timer, the request comprising at least one unique identifier;
accessing a service level agreement in at least one database to based on the at least one unique identifier;
determining, based on the service level agreement:
an end time for the timer, and
an event for triggering at the end time;
saving the received request to a data store comprising a plurality of requests;
upon reaching the end time for the timer associated with the request, trigger the event by sending instructions to perform cancellation of an online order associated with the request; and
responsive to triggering the event, sending, via a network, the event associated with the request.

11. The method of claim 10, wherein the data store comprising the plurality of requests comprises a key-value data structure.

12. The method of claim 11, wherein the received request is stored in the data store by storing the end time for the respective timer as a key and the event as an associated value.

13. The method of claim 12, further comprising:
maintaining a repeating master timer with a pre-defined interval;
determining that the repeating master timer interval has expired; and
based on determining that the repeating master time interval has expired:
locating one or more keys in the data store;
comparing the time stored in the located keys to the current time;
triggering the associated event for at least one located key with an associated time in the past.

14. The method of claim 11, further comprising:
periodically store snapshots of the key-value data store on a computer-readable medium;
determining that data loss has occurred in the key-value data store due to power outage, program error, or other incident;
reading the stored snapshots; and
restoring data to the key-value data store using the stored snapshots.

15. The method of claim 10, further comprising:
maintain a repeating master timer with a pre-defined interval;
determining that the repeating master timer interval has expired; and
based on determining that the repeating master time interval has expired:
consulting the data store to determine one or more requests whose respective end times have been reached;
triggering the associated event for the one or more determined requests.

16. The method of claim 10, further comprising:
sending a notification to a destination system indicating that the timer has elapsed.

17. The method of claim 10, further comprising:
receive, from the first system, a request to cancel the timer; and
clear the received request from the data store.

18. The method of claim 10, wherein sending the event comprises sending the event to the first system.

19. A computer-implemented system for propagating timer management and event triggering, the system comprising:
a memory storing instructions; and
at least one processor configured to execute the instructions to:
receive, from a first system via a network, a request to instantiate a timer, the request comprising at least one unique identifier;
accessing a service level agreement in at least one database based on the at least one unique identifier;
determining, based on the service level agreement:
an end time for the timer, and
an event for triggering at the end time;
save the received request to a data store comprising a plurality of requests;
upon reaching the end time for the timer associated with the request, trigger the event by sending instructions to perform cancellation of an online order associated with the request; and
responsive to triggering the event, send, via a network, the event associated with the request;
maintain a repeating master timer with a pre-defined interval;
determine that the repeating master timer interval has expired; and
based on determining that the repeating master time interval has expired:
locate one or more keys in the data store;
compare the time stored in the located keys to the current time; and
trigger the associated event for at least one located key with an associated time in the past.

20. The system of claim 1, wherein the service level agreement that includes the end time for the timer and the event for triggering at the end time.
